(19) United States
(12) Patent Application Publication
(10) Pub. No.: US 2017/0373316 A1
(43) Pub. Date: Dec. 28, 2017

(54) OLIVINE TYPE POSITIVE ELECTRODE ACTIVE MATERIAL FOR LITHIUM SECONDARY BATTERY, METHOD FOR PREPARING SAME, AND LITHIUM SECONDARY BATTERY COMPRISING SAME

(71) Applicant: SAMSUNG SDI CO., LTD., Yongin-si, Gyeonggi-do (KR)

(72) Inventors: Jae Seung SHIN, Yongin-si, Gyeonggi-do (KR); Young Sun KONG, Yongin-si, Gyeonggi-do (KR); Shin Jung CHOI, Yongin-si, Gyeonggi-do (KR)

(21) Appl. No.: 15/540,416

(22) PCT Filed: Aug. 21, 2015
(86) PCT No.: PCT/KR2015/008736

§ 371 Date: Sep. 20, 2017

(30) Foreign Application Priority Data
Dec. 31, 2014 (KR) 10-2014-0196016

(51) Int. Cl. H01M 4/58; H01M 4/136; C01G 45/00; H01M 10/0525; H01M 4/36

(52) U.S. Cl. CPC H01M 4/5825; H01M 10/0525; H01M 4/366; C01G 45/006; H01M 4/136; C01P 2006/40

(57) ABSTRACT

Provided are an olivine-type positive electrode active material for a lithium secondary battery, a method for preparing the same, and a lithium secondary battery comprising the same, wherein the olivine-type positive electrode active material may be represented by Formula 1:

Li_{w}Mn_{1-(x+y+z)}MₓM′_{y}M⁴¹_{z}PO₄ Formula [1]

wherein, in Formula 1,

0.95<w≦1.05,

0<x≦0.1,

0<y≦5 0.1,

0<z≦0.1,

provided that 0<x+y+z≦0.2, and
M, M′, and M″ are each independently an element selected from the group consisting of Ni, Co, Fe, Mg, V, Zn, Cu, Al, and Ga.

### TECHNICAL FIELD

One or more embodiments relate to an olivine-type positive electrode active material for a lithium secondary battery, a method for preparing the same, and a lithium secondary battery comprising the same, and, more particularly, to an olivine-type positive electrode active material for a lithium secondary battery, wherein the olivine-type positive electrode active material has improved capacity and conductivity by having a short diffusion path without structural change, a method for preparing the same, and a lithium secondary battery comprising the same.

### BACKGROUND ART

As a positive electrode active material of a lithium secondary battery, an example of a compound having an olivine structure may be Formula LiₓM_{y}PO₄ (where, x is 0<x≦2, y is 0.8≦y≦1.2, and M is a transition metal of the 3d block in the periodic table). Among compounds represented by LiₓM_{y}PO₄, LiFePO₄ is environment-friendly, abundant in terms of its raw-material reserve, and cost-effective due to a low price of its raw material. Also, low power and a low voltage may be relatively easily achieved compared to when a material for a conventional positive electrode active material is used, and a theoretical capacity of the compound is 170 mAh/g, which is an excellent battery capacity.

Among the olivine-based positive electrode active materials, LiMnPO₄ may work in a high voltage range (4.1 V) and may have high energy density. However, LiMnPO₄ has low conductivity (<10⁻¹⁰) and low capacity than those of LiFePO₄.

In order to resolve this problem, a method of adding Mn at a large amount to a basic structure of LiFePO₄ (Patent No. WO2010047525 A2) has been disclosed. However, the positive electrode active material prepared by using the method forms two plateaus which makes cell design difficult and thus may not be practically used.

Therefore, one or more embodiments are a result from continued effort to improve conductivity and capacity characteristics without a basic structure of lithium manganese phosphate (LMP) by using a method of introducing another element.

### DETAILED DESCRIPTION OF THE INVENTION

### Technical Problem

According to an embodiment, provided is a positive electrode active material among olivine-based positive electrode active materials, wherein a doping element is added to the positive electrode active material to improve conductivity and capacity characteristics of lithium manganese phosphate (LMP), which does not have good conductivity and capacity characteristics. Also, according to another embodiment, provided is a method for preparing the positive electrode active material. Therefore, an objective of one or more embodiments of the present invention is to provide a material of a lithium secondary battery for practical use by improving characteristics of lithium manganese phosphate to have a large capacity and a high conductivity.

### Technical Solution

According to an embodiment, provided is an olivine-type positive electrode active material that may be represented by Formula 1:

Li_{w}Mn_{1-(x+y+z)}MₓM′_{y}M″_{z}PO₄ [Formula 1]

In Formula 1,

0.95<w≦1.05,

0<x≦0.1,

0<y≦0.1,

0<z≦0.1,

provided that 0<x+y+z≦0.2, and

M, M′, and M″ are each independently an element selected from the group consisting of Ni, Co, Fe, Mg, V, Zn, Cu, Al, and Ga.

For example, the positive electrode active material is in the form of secondary particles.

For example, the positive electrode active material includes a carbon-coating layer.

According to an embodiment, provided is a method for preparing an olivine-type positive electrode active material for a lithium secondary battery, the method including pulverizing and mixing a solution comprising a lithium compound, a manganese compound, and a phosphate compound to obtain a solution mixture; adding a compound comprising a transition metal element having a size smaller than manganese (Mn) as a doping element to the solution mixture and milling the solution mixture to prepare a slurry; spray-drying the slurry to obtain a precursor of a lithium manganese phosphate; and calcining the precursor of a lithium manganese phosphate to obtain the lithium manganese phosphate (LMP).

For example, the doping element is selected from the group consisting of Ni, Co, Fe, Mg, Zn, Cu, Al, and Ga.

For example, the compound including a lithium compound, a manganese compound, a phosphate compound, and a doping element stoicheometrically includes lithium, manganese and doping elements, and a phosphate group at a ratio of 0.95 to 1.05 : 0.98 to 1.02 : 0.98 to 1.02.

For example, a bead mill is used during a pulverizing and mixing process of the solution mixture.

For example, a non-ionic surfactant at an amount in a range of 5 parts to 10 parts by weight based on 100 parts by weight of the precursor may be further added to the slurry.

According to another embodiment, provided is a lithium secondary battery including the positive electrode active material.

### Advantageous Effects of the Invention

According to an embodiment, provided is a positive electrode active material having improved conductivity and capacity characteristics by adding a doping element during a process of preparing an olivine-type lithium manganese phosphate. The positive electrode active material brings about effects of reducing a size of a powder structure by the addition of the doping element, which results in shortening a diffusion path, and thus increasing conductivity. Also, when a precursor in the form of secondary particles having a regular size is obtained through bead mill pulverizing and spray-drying, crystallinity of the precursor may be improved and defects of the particles may be reduced by calcining the precursor, which may result in improving capacity at a C-rate.

According to another embodiment, provided is a lithium manganese phosphate that may be used in designing a practical cell having improved battery characteristics by using a method of simply adding a doping element during a preparation process of the positive electrode active material.

### DESCRIPTION OF THE DRAWINGS

FIGS. 1 and 2 are scanning electron microscope images of a positive electrode active material prepared in Example of an embodiment of the present invention at magnification ratios of 10,000 and 30,000, respectively; and

FIG. 3 is a discharge curve of a lithium secondary battery including the positive electrode active material prepared in Example of an embodiment of the present invention.

### BEST MODE

According to an embodiment, provided is an olivine-type positive electrode active material that may be represented by Fonnula 1:

Li_{w}Mn_{1-(x+y+z)}MₓM′_{y}M″_{z}PO₄ [Formula 1]

In Formula 1,

0.95<w≦1.05,

0<x≦0.1,

0<y≦0.1,

0<z≦0.1,

provided that 0<x+y+z≦0.2, and

M, M′, and M″ are each independently a transition metal element having a size smaller than manganese (Mn) as a doping element and, for example, may be selected from the group consisting of Ni, Co, Fe, Mg, Zn, Cu, Al, and Ga. The doping element reduces a size of a final structure of the positive electrode active material. Since a diffusion path is shortened in the active material particles thus reduced in size, a conductivity of the active material may improve as a result. Also, the element facilitates migration of lithium ions as a ratio of volume change during an oxidation and reduction process is low.

The doping element may be, preferably, included in a plural number to exhibit excellent capacity characteristics at a high-rate charging/discharging process, and, most preferably, the positive electrode active material according to an embodiment may include three doping elements.

In the positive electrode active material according to an embodiment, a doping element is included instead of a manganese element of a lithium manganese phosphate (LMP), and thus, for example, the doping element may be stoicheometrically included at an amount of 20% or less based on the total amount of the doping element and manganese element.

The positive electrode active material is provided in the form of secondary particles. A size of the secondary particles may be advantageous in terms of having a high density and a large surface area. Thus, the positive electrode active material of the present invention may have improved conductivity and density, which may provide a secondary battery having high capacity.

Also, the positive electrode active material may preferably include a carbon-coating layer, and when there is a carbon-coating layer on a surface of and inside the positive electrode active material of the present invention in the form of secondary particles, electrochemical characteristics of a battery prepared by using the positive electrode active material may improve.

To provide the positive electrode active material according to an embodiment, a precursor may be prepared by adding different types of doping elements during a process of preparing a lithium manganese phosphate and calcining the precursor to prepare a positive electrode active material. In particular, according to another embodiment of the present invention, provided is a method for preparing an olivine-type positive electrode active material for a lithium secondary battery, the method including pulverizing and mixing a solution comprising a lithium compound, a manganese compound, and a phosphate compound to obtain a solution mixture; adding a compound comprising a transition metal element having a size smaller than manganese (Mn) as a doping element to the solution mixture and milling the solution mixture to prepare a slurry; spray-drying the slurry to obtain a precursor of a lithium manganese phosphate; and calcining the precursor of a lithium manganese phosphate to obtain the lithium manganese phosphate (LMP).

The lithium compound may be selected from the group consisting of lithium hydroxide, lithium fluoride, lithium nitrate, lithium carbonate, and a combination thereof. The manganese compound may be manganese sulfate, manganese nitrate, manganese chloride, manganese fluoride, and a combination thereof. The phosphate compound may be selected from phosphate, ammonium phosphate, ammonium hydrogenphosphate, lithium phosphate, and a combination thereof.

In the pulverizing and mixing the solution including a lithium compound, a manganese compound, and a phosphate compound, a lithium compound, a manganese compound, and a phosphate compound may be added to pure water, as a solvent, and the pulverizing and mixing may be performed, preferably, by using a bead mill for about 30 minutes to 2 hours.

Next, a transition metal element having a size smaller than manganese (Mn) is used as a doping element to be added to a solution mixture prepared by the pulverizing and mixing, and examples of the transition metal may be Ni, Co, Fe, Mg, Zn, Cu, Al, or Ga. The doping element may be used, preferably, in a plural number to exhibit excellent capacity characteristics at a high rate charging/discharging process, and, most preferably, three doping elements may be used.

In a preparation method for adding a doping element, a compound including a doping element may be added to a solution mixture of the lithium compound, the manganese compound, and the phosphate compound. For example, as the doping element, a compound including iron (Fe) such as iron sulfate, iron chlorate, iron nitrate, or iron phosphate; a compound including cobalt (Co) such as cobalt sulfate, cobalt nitrate, cobalt chloride, or cobalt fluoride; and a compound including magnesium (Mg) such as magnesium oxide, magnesium sulfate, magnesium nitrate, or magnesium chlorate may be added to the solution mixture.

Particles may be pulverized into a very small size or disintegrated during processes of the pulverizing and mixing the solution mixture of the lithium compound, manganese compound, and phosphate compound; and milling the solution mixture after adding a compound of the doping element to the solution mixture. In this regard, the doping elements may be inserted into a lithium manganese phosphate precursor that is pulverized into a small size. Particularly, in the present invention, a transition metal element having a size smaller than manganese (Mn) as a doping element is used, and the element having the condition enters into the pulverized precursor and significantly reduces the particle size. That is, the doping element only reduces the diffusion path while not changing a lithium manganese phosphate structure support obtained by pulverizing and mixing the solution including a lithium compound, a manganese compound, and a phosphate compound.

In the preparation method, when the solution mixture including a lithium compound, a manganese compound, a phosphate compound, and a doping element is added, the lithium compound, a compound including the manganese compound and doping element, and the phosphate compound may be in a range of 0.95 to 1.05 : 0.98 to 1.02: 0.98 to 1.02. When the compound is added within this range, a ratio of the doping element may be stoicheometrically the same with a phosphorus element together with a manganese element, that is 1. Also, a ratio of the lithium element may be in a range of 0.95 to 1.05. Also, the compound including the doping element may be preferably added at an amount of 20% or less stoicheometrically based on the total amount of the compound including the manganese compound and doping element.

A bead mill may be used during the pulverizing and mixing process of the solution mixture including the lithium compound, the manganese compound, and the phosphate compound. A size of beads may be 0.5 mm or less, or preferably 0.3 mm or less. The milling may be performed for 30 minutes to 1 hour. Also, the same beads may be used in the milling performed after adding the compound of the doping element, and the milling may be performed for 3 to 6 hours, and thus a slurry may be obtained.

Since the particles obtained from the mixing and pulverizing by using the bead mill are in the form of secondary particles having a regular size, a conductivity and a density of an active material may improve, and thus using the bead mill is preferable.

Next, the slurry is spray-dried to obtain a precursor of a lithium manganese phosphate. During the spray-drying, preferably, hot air at a temperature of about 280° C. may be used.

Subsequently, the precursor is calcined by adding the precursor into a tube furnace having a temperature-increasing interval/a temperature-maintaining interval/a cooling interval. In the tube furnace, the precursor is slowly heated from room temperature to a temperature of 600 to 800° C., maintained at this state for 10 hours to 20 hours, and naturally cooled. The calcining was performed under a reducing atmosphere. When a temperature of calcining is lower than 600° C., a capacity of the prepared positive electrode active material decreases, and thus a temperature lower than 600° C. is not preferable. When the temperature is higher than 800° C., capacity still decreases, and thus a temperature higher than 800° C. is not preferable as well. Also, when the calcining is performed less than 10 hours, the precursor particles cannot have sufficient crystallinity, and when the calcining is performed more than 20 hours, a period of processing time may be wasted, and an amount of consuming a reduction gas may increase, which is not preferable.

The calcining process improves crystallinity of particles and reduces defects and thus may provide a positive electrode active material that produces effects of improving capacity even at a high C-rate.

In the present invention, when a compound of the doping element is added, a non-ionic surfactant may be further, added, and an amount of the non-ionic surfactant may be 5 parts to 10 parts by weight based on 100 parts by weight of the precursor. The surfactant thus added may be inserted between the lithium manganese phosphate precursor and the doping element, wherein the precursor is pulverized into a small size during a milling process as the precursor is added together with the doping element compound, and when the precursor and the doping element are formed into secondary particles, the surfactant may form a coating layer inside or on a surface of the precursor and the doping element.

Then, according to another embodiment, provided is a lithium secondary battery including the positive electrode active material. The lithium secondary battery includes a positive electrode including the positive electrode active material according to an embodiment; a negative electrode including a negative electrode active material of artificial graphite, natural graphite, graphitized carbon fibers, amorphous carbon, or silicon; and a separator between the positive electrode and the negative electrode. Also, the lithium secondary battery includes liquid or polymer gel electrolyte including a lithium salt and a nonaqueous organic solvent, the electrolyte being impregnated in the positive electrode, the negative electrode, and the separator.

Hereinafter, an embodiment will be described by referring to Example, but the scope of the embodiment is not limited to Example.

### EXAMPLE

Li₂CO₃ as a lithium compound, MnPO₄·2H₂O as a manganese compound, and (NH₄)₂HPO₄ as a phosphate compound were added to pure water as a solvent to prepare a solution mixture (where Li₂CO₃, MnPO₄·2H₂O, and (NH₄)₂HPO₄ included Li, Mn, and a phosphate group at amounts of 1.05 M, 0.85 M, and 1 M, respectively) in a reactor (5L, 25W/60Hz/0.31A, available from E&TEK), and the solution mixture was pulverized and mixed by using a bead mill (at a bead size of 0.3 mm, FCJB-40, available from DnTek) for 30 minutes. Then, as a compound including doping elements, FePO₄·4H₂O as an iron compound, C₄H₆CoO₄·4H₂O as a cobalt compound, and MgH₄P₂O₈ as a magnesium compound were each added so that a concentration of each compound was 0.05 M in the solution. Also, 5 g of Triton x-100 was added thereto as a non-ionic surfactant. Then, the mixture was milled for 4 hours by using the bead mill, and thus, a slurry having a solid amount of 30 weight % was prepared.

The slurry was spray-dried by using a spray-dryer (MD-005R, available from DongjinSD. Colo.), a hot air temperature of 280° C., and a ventilation hot air temperature of 110° C. Particles obtained by solvent evaporation through the spray-drying process were a precursor of lithium manganese oxide having an average particle diameter (D₅₀) of 10 μm.

The precursor was added to a tube furnace having a temperature-increasing zone/a temperature-maintaining zone/a cooling zone, the tube furnace was heated at a temperature increasing rate of 2° C./min from room temperature to 720° C., the temperature was maintained at 720° C. for 10 hours, and naturally cooled to obtain a lithium manganese phosphate. Here, the calcining process was performed under a reduction atmosphere of H₂(1%)/N₂(99%) gas.

### Comparative Example 1

A positive electrode active material was prepared in the same manner as in Example, except that the compound including doping elements was not added.

### Comparative Example 2

A positive electrode active material was prepared in the same manner as in Example, except that FePO₄·4H₂O as an iron compound was only used as the compound including a doping element.

### Comparative Example 3

A positive electrode active material was prepared in the same manner as in Example, except that C₄H₆Co0₄·4H₂O as a cobalt compound was only used as the compound including a doping element.

### Comparative Example 4

A positive electrode active material was prepared in the same manner as in Example, except that MgH₄P₂O₈ as a magnesium compound was only used as the compound including a doping element.

### Comparative Example 5

A positive electrode active material was prepared in the same manner as in Example, except that FePO₄·4H₂O as an iron compound and MgH₄P₂O₈ as a magnesium compound were used as the compound including a doping element.

(Determination of Positive Electrode Active Material Powder)

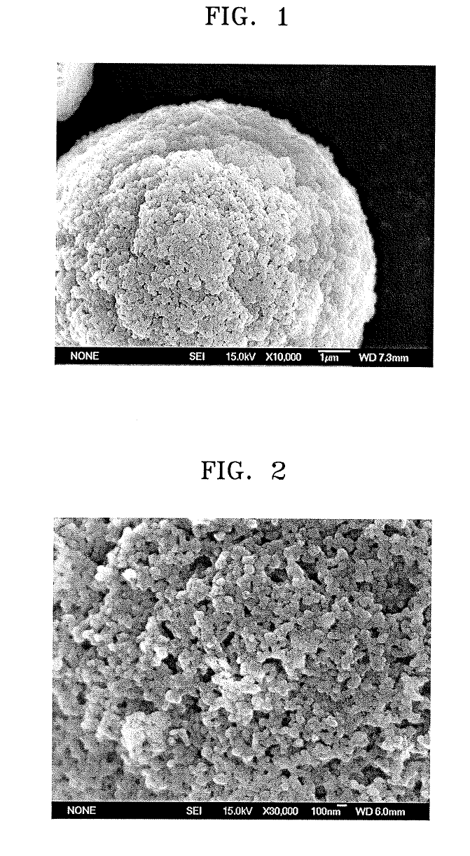

A powder of the positive electrode active material prepared in Example was observed by using a scanning electron microscope (SEM, JSM6400, available from JEOL). FIGS. 1 and 2 are images of a positive electrode active material prepared in Example of an embodiment of the present invention at magnification ratios of 10,000 and 30,000, respectively.

(Determination of the Battery Property of Lithium Secondary Battery)

Each of the positive electrode active material powders prepared in Example and Comparative Examples 1 to 5, acetylene black as a conducting agent, and polyvinylidene fluoride (PVdF) as a binder were mixed at a weight ratio of 90:5:5 to prepare a slurry. The slurry was homogenously applied on an aluminum foil having a thickness of 18 μm and vacuum-dried at 120° C. to prepare a positive electrode. The positive electrode thus prepared, lithium foil as a counter electrode, and porous polyethylene film (having a thickness of 25 ₁, 1m, Celgard2300, available from Celgard LLC) as a separator were used, and liquid prepared by dissolving LiPF₆ at a concentration of 1 M in a solvent having ethylene carbonate and diethyl carbonate at a volume ratio of 1:1 was used as an electrolyte solution to prepare a coin cell. The coin cell underwent a charging/discharging test at a cycle rate of 0.1 C, 0.2 C, 0.5 C, 11 C, or 5 C within a potential range of 2.0 V to 4.0 V at a temperature of 30° C. by using an electrochemical analyzer (Toscat 3100U, available from Toyo System).

The results of measuring a capacity of the battery from the test are shown in Table 1.

TABLE 1

| Sample | 0.1 C | 0.2 C | 0.5 C | 1 C | 5 C |
|---|---|---|---|---|---|
| Example | 138.0 | 136.9 | 132.1 | 125.7 | 95.4 |
| Comparative | 131.7 | 125.2 | 116.5 | 107.8 | 58.3 |
| Example 1 | | | | | |
| Comparative | 130.6 | 129.1 | 120.4 | 111.6 | 59.2 |
| Example 2 | | | | | |
| Comparative | 131.8 | 128.3 | 118.9 | 110.6 | 60.2 |
| Example 3 | | | | | |
| Comparative | 132.5 | 127.5 | 118.5 | 109.2 | 48.2 |
| Example 4 | | | | | |
| Comparative | 135.2 | 130.4 | 122.3 | 114.5 | 64.2 |
| Example 5 | | | | | |

(unit: mAh/g)

In Table 1, it may be confirmed that when iron, cobalt, or magnesium was used as a doping element, capacities were significantly improved than when no doping element was added (Comparative Example 1) or when one doping element (Comparative Examples 2 to 4) or two doping elements (Comparative Example 5) are included. This was the same result in in a high rate charging/discharging test. This is because the battery may exhibit good capacity characteristics at a high rate due to their conductivity improvement.

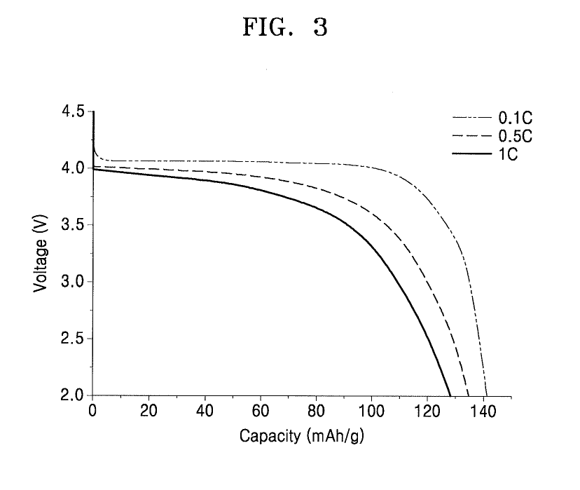

Also, capacity change of the battery including the positive electrode active material of Example was discharged at 0.1 C, 0.5 C, or 1 C as shown in FIG. 3. In a discharge curve, one plateau is well observed. Therefore, it may be confirmed that the positive electrode active material according to an embodiment is stable.

1. An olivine-type positive electrode active material represented by Formula 1:
Li_{w}Mn_{1-(x+y+z)}MₓM′_{y}M″_{z}PO₄ [Formula 1]
wherein, in Formula 1,
0.95<w≦1.05,
0<x≦0.1,
0<y≦0.1,
0<z≦0.1,
provided that 0<x+y+z<0.2, and
M, M′, and M″ are each independently an element selected from the group consisting of Ni, Co, Fe, Mg, V, Zn, Cu, Al, and Ga.

2. The olivine-type positive electrode active material of claim 1, wherein the positive electrode active material comprises a carbon-coating layer.

3. A method for preparing the olivine-type positive electrode active material as claimed in claim 1, the method comprising:
milling a solution comprising a lithium compound, a manganese compound, and a phosphate compound to obtain a solution mixture;
adding a compound comprising a transition metal element having a size smaller than manganese (Mn) as a doping element to the solution mixture and milling the solution mixture to prepare a slurry;
spray-drying the slurry to obtain a precursor of a lithium manganese phosphate; and
calcining the precursor of a lithium manganese phosphate to obtain the lithium manganese phosphate (LMP) olivine-type positive electrode active material.

4. The method of claim 3, wherein the compound comprising a lithium compound, a manganese compound, a phosphate compound, and a doping element stoicheometrically comprises lithium, manganese and doping elements, and a phosphate group at a ratio of 0.95 to 1.05 : 0.98 to 1.02 : 0.98 to 1.02.

5. The method of claim 3, wherein the slurry further comprises a non-ionic surfactant at an amount in a range of 5 parts to 10 parts by weight based on 100 parts by weight of the precursor.

6. A lithium secondary battery comprising the positive electrode active material prepared according to claim 1.
